(19) United States
(12) Patent Application Publication
(10) Pub. No.: US 2022/0342054 A1
(43) Pub. Date: Oct. 27, 2022

(54) ATTITUDE/POSITION DETECTION SYSTEM AND METHOD FOR DETECTING ATTITUDE/POSITION OF DETECTOR

(71) Applicant: DENSO CORPORATION, Kariya-city (JP)

(72) Inventor: Kazuki Katou, Kariya-city (JP)

(21) Appl. No.: 17/811,451

(22) Filed: Jul. 8, 2022

Related U.S. Application Data
(63) Continuation of application No. PCT/JP2020/047169, filed on Dec. 17, 2020.

(30) Foreign Application Priority Data
Jan. 10, 2020 (JP) 2020-002524

(51) Int. Cl. G01S 7/497

(52) U.S. Cl. CPC G01S 7/497

(57) ABSTRACT

In an attitude/position detection system for a detector mounted to a vehicle, an attitude/position detection device is configured to use a change in position of a movable component of the vehicle to perform attitude/position detection for the detector. The detector is mounted to the vehicle such that at least a part of the movable component of the vehicle is included in a detection region.

### CROSS-REFERENCE TO RELATED APPLICATION

This application is a continuation application of International Application No. PCT/JP2020/047169 filed Dec. 17, 2020 which designated the U.S. and claims priority to Japanese Patent Application No. 2020-002524 filed Jan. 10, 2020, the contents of each of which are incorporated herein by reference.

### BACKGROUND

### Technical Field

This disclosure relates to a technique for detecting an attitude and a position of a detector used on-board a vehicle.

### Related Art

A technique has been proposed for calibrating a detector on-board a vehicle to acquire proper detection results from the on-board detector.

### BRIEF DESCRIPTION OF THE DRAWINGS

In the accompanying drawings:

FIG. 1 is a schematic diagram of a detector attitude/position detection system according to a first embodiment;

FIG. 2 is an illustration of an example of a vehicle equipped with detectors;

FIG. 3 is an illustration of a result of detection of an object by a plurality of detectors;

FIG. 4 is an illustration of an example of movable-component related detectors installed in a vehicle;

FIG. 5 is an illustration of open and closed positions of each door as a movable component when an attitude/position of a movable-component related detector is correct;

FIG. 6 is an illustration of open and closed positions of a door as a movable component when there is a deviation in attitude/position of a movable-component related detector;

FIG. 7 is an illustration of a home position of each wiper as a movable component when an attitude/position of a movable-component related detector is correct;

FIG. 8 is an illustration of a home position of each wiper as a movable component when there is a deviation in attitude/position of a movable-component related detector;

FIG. 9 is a functional block diagram of an attitude/position detection device of the first embodiment;

FIG. 10 is a flowchart illustrating a process flow of an attitude/position detection process performed by the attitude/position detection device of the first embodiment;

FIG. 11 is an illustration of a reference attitude of the vehicle;

FIG. 12 is an illustration of an example of a change in attitude of the vehicle; and

FIG. 13 is a flowchart illustrating a process flow of an attitude/position detection process performed by an attitude/position detection device according to a second embodiment.

### DESCRIPTION OF SPECIFIC EMBODIMENTS

Conventional calibration, as disclosed in JP 2017-26551 A, is performed using a calibration booth and targets during shipment from a factory or during vehicle repair or inspection, but does not take into account dynamic variations in attitude/position of each detector on-board the vehicle after start of travel.

In view of the foregoing, it is desired to have a technique for efficiently detecting at least one of an attitude and a position of each detector on-board a vehicle after start of travel.

A first aspect of the present disclosure provides an attitude/position detection system for a detector mounted to a vehicle. The attitude/position detection system according to the first aspect includes: an attitude/position detection device configured to use a change in position of a movable component of the vehicle to perform attitude/position detection for the detector; and the detector is mounted to the vehicle such that at least a part of the movable component of the vehicle is included in a detection region.

In accordance with the attitude/position detection system according to the first aspect, at least one of an attitude and a position of a detector on-board a vehicle after start of travel can be efficiently detected.

A second aspect provides an attitude/position detection method for a detector mounted to a vehicle such that at least a part of a movable component of the vehicle is included in a detection region of the detector. The attitude/position detection method according to the second aspect includes: acquiring position information of the movable component of the vehicle; and performing attitude/position detection for the detector using the acquired position information.

In accordance with the attitude/position detection method for a detector mounted to a vehicle according to the second aspect such that at least a part of a movable component of the vehicle is included in a detection region of the detector, at least one of an attitude and a position of the on-board detector after start of travel can be efficiently detected.

A third aspect of the present disclosure provides an attitude/position detection system for a detector mounted to a vehicle. The attitude/position detection system according to the first aspect includes: a vehicle attitude detection device configured to detect a change in attitude of the vehicle when entering or exiting the vehicle; and an attitude/position detection device configured to calibrate the detector using the detected change in attitude of the vehicle when entering or exiting the vehicle.

In accordance with the attitude/position detection system according to the third aspect, at least one of an attitude and a position of an on-board detector after start of travel can be efficiently detected.

A fourth aspect of the present disclosure provides an attitude/position detection method for a detector mounted to a vehicle. The attitude/position detection method according to the fourth aspect includes: detecting a change in attitude of the vehicle when entering or exiting the vehicle; and calibrating the detector using the detected change in attitude of the vehicle when entering or exiting the vehicle.

In accordance with the attitude/position detection method according to the fourth aspect, at least one of an attitude and a position of an on-board detector after start of travel can be efficiently detected. The present disclosure may also be implemented as a program for detector attitude/position detection or as a computer-readable storage medium storing said program.

Hereinafter, an attitude/position detection system and an attitude/position detection method for detecting attitudes/positions of on-board measuring devices according to the present disclosure will now be described based on some exemplary embodiments.

### First Embodiment

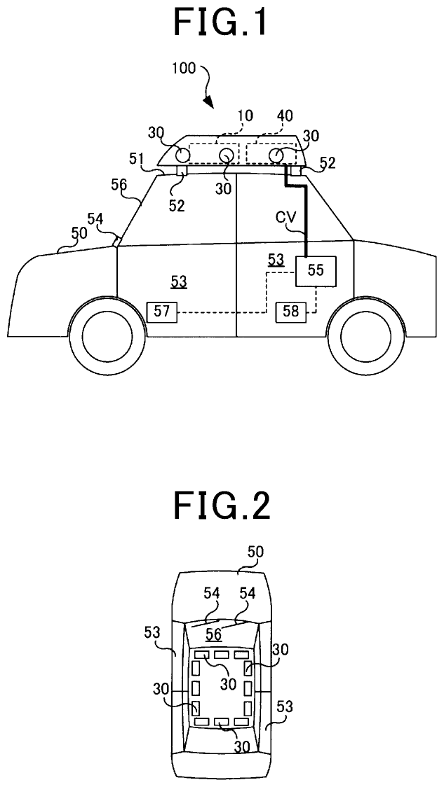

As illustrated in FIG. 1, an attitude/position detection system 100 of a first embodiment includes at least an attitude/position detection device 10. In the present embodiment, the attitude/position detection device 10 is provided in a vehicle 50, but may be portable and connectable to a communication system of the vehicle 50 and capable of acquiring detection data from detectors 30. In this specification, the “attitude/position” means at least one of an attitude and a position. As illustrated in FIGS. 1 and 2, the vehicle 50 has a plurality of detectors 30 mounted on a roof 51 via a fixing mechanism 52 and a data processing unit 40 connected to the detectors 30. The detectors 30 include a plurality of types of detectors using different detection methods, such as a camera, light detection and ranging/laser imaging detection and ranging (Lidar), and millimeter wave radar. The detectors 30 may be provided, for example, on a front grille, a front window, a front bumper, a rear window, a rear bumper, a front fender, or a rear fender of the vehicle 50, or may be provided on any one of them. The data processing unit 40 may be connected to the vehicle control unit 55 via a cable CV inside the vehicle 50. The data processing unit 40 integrates detection data received from the plurality of detectors 30 to generate integrated data and transmits the integrated data to the vehicle control device 55 inside the vehicle 50. The vehicle control unit 55 is configured to perform driving assistance or autonomous driving, and control, via various actuators (not shown), output power of an internal combustion engine or a motor in response to or irrespective of driver's operations of an accelerator pedal, and enable braking by a braking device irrespective of driver's operations of a brake pedal, or enable steering by a steering device irrespective of driver's operations of a steering wheel. The data processing unit 40 may include, as part of its function, an attitude/position detection function similar to that provided by the attitude/position detection device 10. Communications between the attitude/position detecting device 10 and the change mechanism actuator 11 may be provided by cable-wired communications, or by various wireless communications, such as wireless LAN or Bluetooth™.

The vehicle 50 has wipers 5 disposed on the doors 53, front windows 56. The doors 53 and wipers 54 form movable components. The movable components are equipment of the vehicle 50 that can make a position change between an open and a closed position or between a home and an actuation position. The movable components include not only the doors 53 and the wipers 54, but also a trunk, a hood, door mirrors, and rotary seats. The closed or open position of the movable component, or at least one of the home and actuation positions, is a defined position that is repeatable and reproducible and can be a reference position. The vehicle 50 also includes a vehicle speed sensor 57 for detecting the speed of the vehicle 50, and a vehicle attitude sensor 58 for detecting the attitude of the vehicle 50. The vehicle attitude sensor 58 is a vehicle attitude detection device and may include, for example, a sensor capable of detecting the occupant's riding position, such as a seat belt sensor or a seat occupant sensor, or a suspension sensor that detects an amount of suspension stroke. The vehicle attitude sensor 58 is not indispensable in the first embodiment.

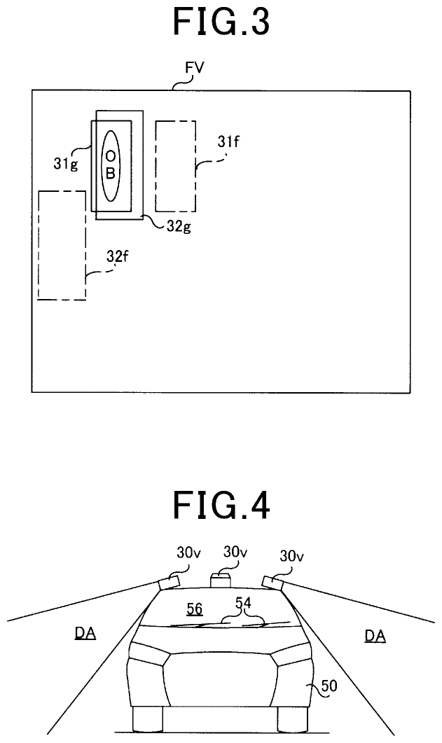

Referring to FIG. 3, results of detection of an object by the respective detectors 30 and deviations between these detection results will be described. In the present embodiment, the detectors 30 are mounted to the vehicle 50 such that a detection region of each detector 30 overlaps a detection region of its adjacent or nearby detector 30. As schematically illustrated in FIG. 3, detected positions 31f, 31g, 32f, 32g of the object by the first and second detectors 30 as example adjacent detectors 30 are superimposed in the forward field of view FV of the vehicle 50. When each of the first and second detectors is mounted to the vehicle 50 in a predefined attitude, that is, in a predefined vertical or horizontal orientation or position, the position of the object OB overlaps the detected positions 31g, 32g by the first and second detectors 30. On the other hand, when neither the first nor second detector is mounted to the vehicle 50 in a predefined attitude relative to the vehicle 50, then the position of the object OB does not overlap any of the detected positions 31f, 32f by the first and second detectors 30. In cases where the attitude/position of either the first or second detector is different from a predefined attitude/position, the detected position 31g by the first detector is acquired while the detected position 32f by the second detector is acquired. Thus, a deviation occurs between the detected positions by the first and second detectors. Such a deviation of detected positions may lead to misrecognition of the position of the object OB relative to the vehicle 50, leading to a decrease in the accuracy of performance of driving assistance and autonomous driving targeting the object OB. Typically, when the vehicle 50 goes off line or when repairs are performed on the vehicle 50 that involve removal and installation of a detector 30, the attitude and position of the detector 30 relative to the vehicle will be calibrated. However, even after start of travel, the attitude and position of the detector 30 relative to the vehicle 50 are detected even when flying objects, such as birds, pebbles, or hail, directly hit the detector 30 or even when indirect stresses are applied to the detector 30 due to a large impact input to the vehicle 50. In such cases, calibration or aiming needs to be performed to physically adjust the attitude of the detector 30 using the detected attitude or correct the detection data received from the detector 30 by using a difference between the detected attitude and a predefined attitude as a correction value.

As illustrated in FIG. 4, at least some of the plurality of detectors 30 are movable-component related detectors 30v disposed on the vehicle 50 such that at least part of a door 53 or a wiper 54 as a movable component is included in a detectable detection region DA or in a detection field of view FV as viewed from the detection axis of the detector 30v. The moving-part related detector 30v may include not only the movable component but also part of the body of the vehicle 50 in the detection field of view FV. However, using a movable component, whose position is significantly displaced between closed and open positions or between home and actuation positions, as being subjected to detection of the attitude/position of the detector 30 relative to the vehicle 50, leads to an increased probability that the detection target will enter the detection field of view FV, which improves the accuracy and reliability of detection of the attitude/position of the detector 30. For simplicity of representation, closed and open positions of a movable component will exemplarily be used in the following. In the present embodiment, focusing on a deviation between results of detection of the open or closed position of a movable component, that is, a difference in detected position relative to the position where it should be, an attitude or position deviation of the movable-component related detector 30v relative to the vehicle 50 is detected. Using the attitude or position deviation of the movable component allows an attitude or position deviation of the detector 30 to be detected without using a dedicated target for detecting an attitude or position deviation, even after the vehicle 50 has started travel or moving.

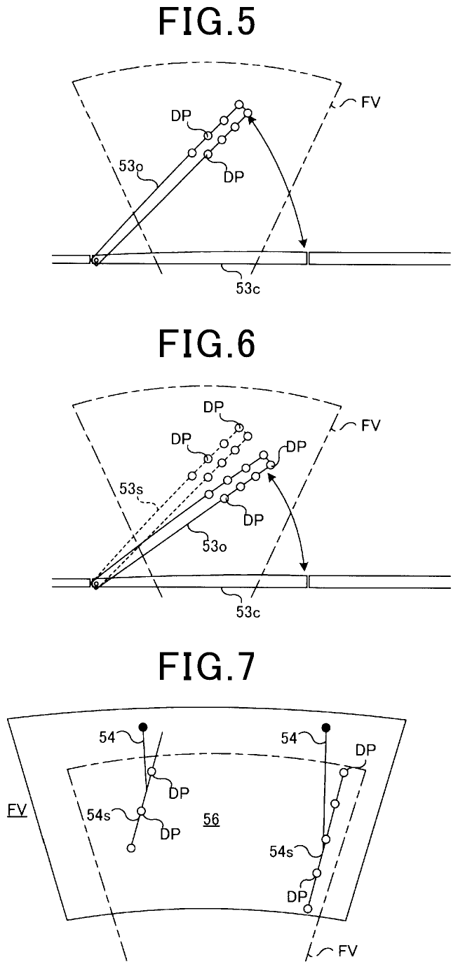

FIGS. 5 and 6 schematically illustrate a detection field of view FV of a movable-component related detector 30v having a door 53 in its detection region DA. The movable-component related detector 30v is, for example, Lidar. Detection data is formed of a plurality of detection points DP indicating edges of an object, such that the door 53 is represented by a group of detection points DP. Alternatively, the movable-component related detector 30v may be a camera, in which case detection data is formed of a plurality of pixel points indicating an object. An edge extraction process or the like is performed on the pixel points to determine a position of the door 53. As illustrated in FIG. 5, the door 53 has a closed position 53c and an open position 53o. The open position 53o corresponds to a position of the door 53 when an occupant enters or exits the vehicle 50. In FIG. 5, the maximum open position of the door 53 is shown. In cases where the attitude or position of the movable-component related detector 30v relative to the vehicle 50 is different from a predefined attitude or predefined position, the open position 53o is detected in a different position than in an original position, that is, a reference open position 53s, as illustrated in the FIG. 6. The reference open position 53s is set to the maximum open position of the door 53, as illustrated in FIG. 5, to ensure uniqueness. The attitude/position detector 10 may be configured to, in response to there being an attitude or position deviation between the reference open position 53s and the detected open position 53o, detect an attitude or position deviation of the movable component related detector 30v relative to the vehicle 50. Furthermore, the reference open position 53s and the detected open position 53o may be used to calculate an amount of deviation using the respective coordinate positions of the reference open position 53s and the detected open position 53o. The reference open position 53s of the door 53 may be the open position as opened by a user of the vehicle 50, which is learned by the attitude/position detection device 10. Furthermore, in cases where the door 53 is automatically opened and closed, the maximum open position is appropriate as the reference open position 53s, and the maximum open position has high repeatability.

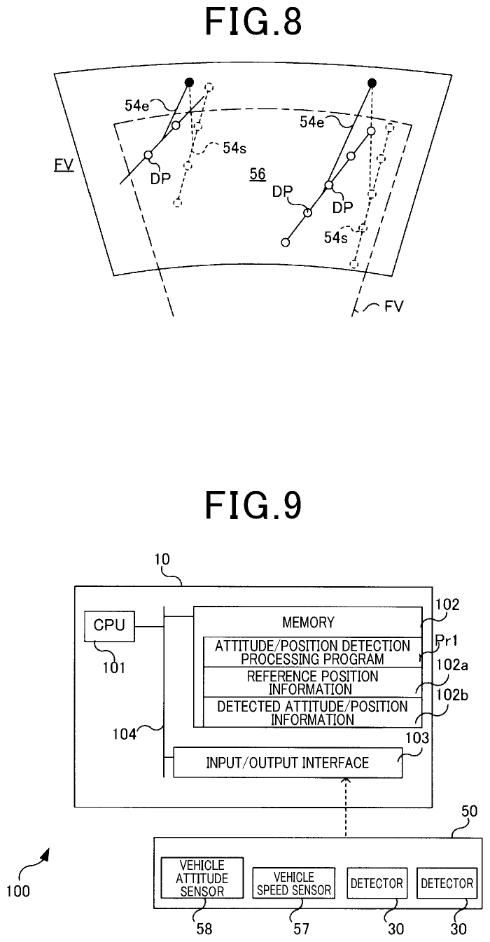

FIGS. 7 and 8 schematically illustrate a detection field of view of a movable-component related detector 30v, including a wiper in its detection region. The movable-component related detector 30v is, for example, Lidar, which represents the wiper using the group of detection points. Alternatively, the movable-component related detector 30v may be a camera. As illustrated in FIG. 7, the wiper 54 slides over a surface of the front window 56 from the home position to the maximum actuation position 54s. In cases where the attitude or position of the movable-component related detector 30v relative to the vehicle 50 is different from a predefined attitude or position, the wiper 54 is detected in a different detected position 54e than the maximum actuation position 54s that is the reference position, as illustrated in FIG. 7. In response to there being a deviation between the maximum actuation position 54s and the detected position 54e, the attitude or position deviation of the movable-component related detector 30v relative to the vehicle 50 may be detected. Furthermore, an amount of deviation may be calculated using coordinate positions of the maximum actuation position 54s and the detected position 54e.

As illustrated in FIG. 9, the attitude/position detection device 10 includes a central processing unit (CPU) 101 as a calculation unit, a memory 102 as a storage unit, an input/output interface 103 as an input/output unit, and a clock generator (not shown). The CPU 101, the memory 102, the input/output interface 103, and the clock generator are bidirectionally communicatively connected via an internal bus 104. The memory 102 includes a non-volatile read-only memory storing an attitude/position detection processing program Pr1 for performing the attitude/position detection process, such as the ROM, and a memory that can be read/written by the CPU 101, such as the RAM. The attitude/position detection processing program Pr1 includes not only a program for detecting an attitude/position of a detector 30 using detection data from the detector 30, but also a program for calibrating the attitude/position of a detector 30 according to the detected attitude/position of the detector 30 and the attitude of the vehicle 50. The non-volatile and read-only area of the memory 102 includes a reference position information storage area 102a that stores reference position information indicating reference positions of the movable components of the vehicle 50, and a detected attitude/position information storage area 102b that stores detected attitude/position information of the detectors 30. The non-volatile and read-only area may be rewritable when updating the program or recording the detected attitude/position. The CPU 101, or the attitude/position detection device 10, functions as an attitude/position detection device and a vehicle attitude detection device by deploying the attitude/position detection processing program Pr1 stored in the memory 102 into the readable and writable memory and performing the attitude/position detection process. The CPU 101 may be a single CPU, multiple CPUs executing respective programs, or a multi-tasking or multi-threaded CPU capable of executing multiple programs simultaneously.

The input/output interface 103 is connected to the detectors 30, the vehicle speed sensor 57, and the vehicle attitude sensor 58. The input/output interface 103 receives detection data detected by the detectors 30, a vehicle speed detected by the vehicle speed sensor 57, and a vehicle attitude detected by the vehicle attitude sensor 58.

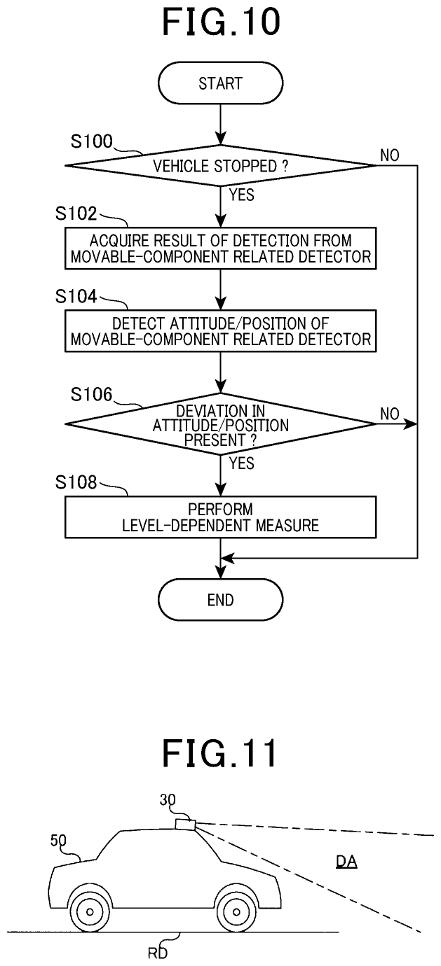

Referring to FIG. 10, the detector attitude/position detection process performed by the detector attitude/position detection system 100 will be described. Each process step illustrated in FIG. 10 is performed by the attitude/position detection device 10, that is, by the CPU 101 executing the attitude/position detection process program Pr1. Upon start up of the detector attitude/position detection system 100, the attitude/position detection process program Pr1 is repeatedly executed at predefined time intervals, e.g., every several milliseconds.

The attitude/position detection device 10, that is, the CPU 101, determines whether the vehicle is stopped (at step S100). For example, if the vehicle speed detected by the speed sensor 57 continues to be 0 km/h for a predetermined period of time, the CPU 101 may determine that the vehicle 50 is stopped. The predefined period of time is, for example, 5 to 10 seconds. The vehicle 50 may be stopped, for example, by observing a stop signal or in a traffic jam. If the CPU 101 determines that the vehicle 50 is not stopped (“NO” branch of step S100), then the CPU 101 ends this processing routine. If the CPU 101 determines that the vehicle 50 is stopped (“YES” branch of step S100), the CPU 101 acquires detection results, that is, detection data, from a movable-component related detector 30v that includes a corresponding movable component in its detection region, among the detectors 30 (at step S102). In some embodiments, there may be a plurality of such movable-component related detectors 30v. Acquisition of the detection data may be performed dynamically. That is, the detection data may be directly acquired from the movable-component related detector 30v. Alternatively, acquisition of the detection data may be performed by acquiring the detector attitude/position information stored in the detected attitude/position information storage area 102b of the memory 102 at different timings. The CPU 101 detects the attitude/position of the movable-component related detector 30v relative to the vehicle 50 using the acquired detection data (at step S104). The CPU 101 extracts one or more feature points of each movable component from the detection data to acquire the detected coordinate position of the movable component determined by the feature points. Extraction of the feature points is achieved by extracting corner points of a target from a group of detection points acquired by Lidar as a detector, or by extracting pixels of corners of a target from an image captured by a camera as a detector. For example, the Harris corner detection method is known.

Upon detecting the attitude/position of the movable-component related detector 30v relative to the vehicle 50, the CPU 101 determines whether there is a deviation in at least one of the attitude and position of the movable-component related detector (at step S106). Specifically, the CPU 101 compares the detected coordinate position that is detected position information of the movable component with the reference coordinate position of the movable component acquired from the reference position information of the movable component stored in the reference position information storage area 102a of the memory 102. As a result of comparison, if an amount of deviation between the detected coordinate position and the reference coordinate position is zero or within a predefined range of deviation amounts, it is determined that there is neither attitude nor position deviation in the movable-component related detector 30v, and if the amount of deviation between the detected coordinate position and the reference coordinate position exceeds the predefined range of deviation amounts, it is determined that there is a deviation in either one of the attitude and position of the movable-component related detector 30v. The coordinate position is expressed in terms of 3D coordinates (x, y, z) and angles (pitch, roll, yaw). A deviation of the detected coordinate position relative to the reference coordinate position may be used to detect the detected position of the movable component acquired by the movable-component related detector relative to the reference position of the movable component as an amount of deviation in coordinate position. The detected coordinate position of the movable component determined by feature points may be compared with the reference coordinate position for each feature point when there are multiple feature points, or the detected coordinate position may be compared with the reference coordinate position for the average coordinate position of multiple feature points. Alternatively, multiple feature points may be associated to each other, where the equation X′=RX+T may be applied to four or more associated points to calculate the attitude R and the position T. The attitude R is represented by a 3×3 matrix and the position T is represented by a 3×1 matrix. The association is implemented, for example, using the known nearest neighbor method or the Global Nearest Neighbor method.

If the CPU 101 has detected neither attitude nor position deviation of the movable-component related detector (“NO” branch of step S106), then the CPU 101 ends the processing routine. If the CPU 101 has detected at least one of attitude and position deviations of the movable-component related detector (“YES” branch of step S106), the CPU 101 performs a level-dependent measure (at step S108) and ends the processing routine. The level-dependent measures include, for example, notification of a message prompting inspection or lighting of an indicator light in cases where the amount of deviation is small and does not affect the control of the vehicle 50, such as driving assistance, and notification of a message prompting the vehicle 50 to stop, or notification of a message or lighting of an indicator light indicating that the driver assistance system is to stop, in cases where the amount of deviation is large enough to affect the control of the vehicle 50, such as driving assistance. The calculated deviation amount for the movable-component related detector 30v may be stored in the detected attitude/position information storage area 102b.

The detector attitude/position detection system 100 of the first embodiment described above enables detector attitude/position detection using changes in position of a movable component detected by the movable-component related detector 30v mounted to the vehicle 50 such that a part of the body of the vehicle 50 is included in the detection region. This allows at least one of the attitude and the position of the detector 30 in the vehicle 50 after start of travel to be efficiently detected. That is, using changes in position of a movable component allows the attitude/position (i.e., at least one of the attitude and position) of the detector 30 relative to the vehicle 50 to be detected without using a dedicated target or a dedicated booth for detecting the attitude/position of the detector 30, which enables dynamic detection of the attitude/position of the detector relative to the vehicle 50 at arbitrary timing after start of travel. In addition, using a movable component having a large position displacement as a detection target facilitates inclusion of the detection target in the detection field of view FV of the movable-component related detector 30v, thereby improving the detection accuracy, detection precision, and reliability. As a result, through calibration of each detector 30 using the detected attitude/position, the control accuracy and control reliability of vehicle control using detection data output by detectors, for example, driving assistance and autonomous driving, can be improved.

In the first embodiment, only attitude/position detection for the movable-component related detector 30v is performed. Additionally, attitude/position detection for another detector may be performed using the movable-component related detector 30v while the vehicle 50 is moving or stopped. This can be performed when each detector 30 is mounted to the vehicle 50 such that the detection region of the detector 30 overlaps at least a portion of the detection region of another detector, more specifically, such that the detection region of the movable-component related detector 30v overlaps at least a portion of the detection region of another detector 30. Specifically, the attitude/position of the other detector 30 relative to the attitude/position of the movable-component related detector 30v may be detected as an amount of deviation in coordinate position, that is, a difference in orientation and position. The attitude/position detection of the other detector 30 using the movable-component related detector 30v is implemented by the previously described methods using the feature points. That is, one of the previously described detection schemes may be performed using the feature points corresponding to the movable-component related detector 30v and the feature points corresponding to the other detector 30. The calculated amount of deviation of the movable-component related detector 30v may be stored in the detected attitude/position information storage area 102b.

In the first embodiment, all the detectors 30 may be movable-component related detectors 30v. That is, the detector 30 disposed at the front can detect open and closed positions of the wiper 54 and the hood, while the detector 30 disposed at the rear can detect open and closed positions of the trunk. In such an embodiment, detection of attitude/position deviation of each detector 30 relative to the movable-component related detector 30v is not necessary.

In the first embodiment, a condition for initiating the attitude/position detection process of the detectors 30 is that the vehicle 50 is stopped. Alternatively, detection of an attitude or a position of each detector 30 relative to the vehicle 50 may be initiated even if the vehicle is not stopped. For example, attitude/position detection using the open position of the door mirror or the position of the wiper 54 may be performed even when the vehicle 50 is in motion. In some driving conditions of the vehicle, some or all detectors 30 may not be necessarily subjected to the detection process, where the time required for attitude/position deviation detection may be extremely short, such as a few milliseconds. This can increase the opportunity for detection of at least one of an attitude and a position of each detector 30 relative to the vehicle 50. Instead of performing the detector attitude/position detection process every time the vehicle 50 is stopped, the detector attitude/position detection process may be performed only at predefined locations, for example, at bus stops or cab boarding/alighting areas. The predefined locations may be detected, for example, by using Global Navigation Satellite System (GNSS).

In the detector attitude/position detection system of the first embodiment, the attitude/position of each movable-component related detectors 30v is only detected. Alternatively, using the amounts of deviation in attitude/position stored in the detection attitude/position information storage area 102b, calibration or aiming may be performed for each of the detectors 30, including the movable-component related detectors 30v. This calibration or aiming may be performed after start of travel of the vehicle 50 or during inspection of the vehicle 50. Calibration or aiming may be performed in hardware, for example, by physically correcting the orientation of each detector 30 so as to compensate the detected amount of attitude/position deviation from the desired detector attitude/position, specifically, directional deviations in the horizontal and vertical directions. Alternatively, calibration or aiming may be performed in software, for example, by correcting coordinate information in the detection data acquired from each detector 30. When performed in software, the attitude/position detection device 10 may input correction information to a detection data generation unit provided in each detector 30, and each detector 30 may output detection data on which the calibration or aiming process was performed. Alternatively, the attitude/position detection device 10 may input correction information to the data processing unit 40, and the data processing unit 40 may perform the calibration or aiming process on the detection data output from each detector 30 and then output the processed detection data to the vehicle control unit 55. Furthermore, the correction information may be input from the attitude/position detection device 10 to the vehicle control device 55, and the vehicle control device 55 may perform a calibration or aiming process on the detection data output from each detector 30, and then use the detection data for various processes. These embodiments may be implemented in any one of cases where the attitude/position detection device 10 is installed in the vehicle and where the attitude/position detection device 10 is not installed in the vehicle.

The detector attitude/position detection system 100 of the first embodiment may also be applied to sensors that check a condition of the driver or monitor the interior of the vehicle, where a rotary seat may be used as a movable component. For example, a position displacement of the rotary seat that rotates 90 degrees relative to the direction of travel may be used to assist occupants in entering or exiting the vehicle. In the first embodiment, the open position or the maximum actuation position of the movable component is used as the reference position and the position to be detected. Alternatively, the closed position or the home position of the movable component may be used as the reference position and the position to be detected, depending on the mounting position or the mounting attitude of the movable-component related detector 30v.

### Second Embodiment

The detector attitude/position detection system of the second embodiment differs from the detector attitude/position detection system 100 of the first embodiment in that it performs detection of changes in attitude of the vehicle caused by occupants entering and exiting the vehicle or loading and unloading luggage at the timings of entering and exiting the vehicle and does not use a change in position of a movable component to detect an attitude/position of a detector 30 relative to the vehicle 50. The detector attitude/position detection system of the second embodiment is similar in configuration to the detector attitude/position detection system of the first embodiment, except that the attitude/position detection processing program Pr1 does not use a change in position of a movable component to detect an attitude/position of a detector 30 relative to the vehicle 50, but detects changes in attitude of the vehicle 50 at the timings of the occupants entering and exiting the vehicle 50 and calibrates the detectors 30. Therefore, in the second embodiment, the same reference numerals are assigned as in the first embodiment and description thereof will be omitted.

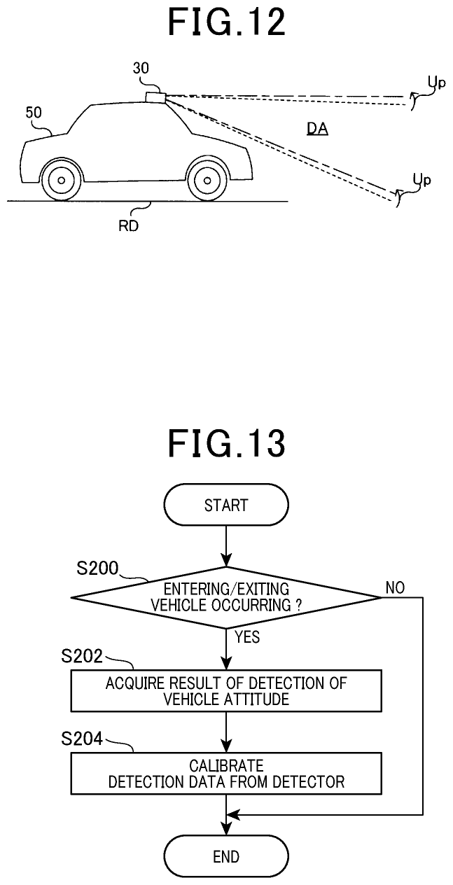

The vehicle 50 may assume, for example, an attitude illustrated in FIG. 11 or an attitude illustrated in FIG. 12, depending on seated positions of occupants and luggage loaded on the vehicle 50. The attitude of the vehicle illustrated in FIG. 12 is an example attitude when a plurality of occupants are seated in the rear seats or when heavy loads are loaded in the trunk. In the example illustrated in FIG. 12, the vehicle is tilted backward and the detection region of the detector 30 is shifted upward, as indicated by the arrow Up, as compared to the example illustrated in FIG. 11. As a result, the attitude of the vehicle 50 relative to the external environment may deviate from the reference attitude illustrated in FIG. 11, and even in cases where the attitude/position of the detector 30 relative to the vehicle 50 is correct, an error may occur in the position of an object subjected to detection by the detector 30. Such an error in detected position may reduce the accuracy of various vehicle control processes that use detection data from the detector 30, such as driving assistance and autonomous driving. In the present embodiment, detecting changes in attitude of the vehicle 50 relative to the external environment during occupants entering and exiting the vehicle and reflecting them in calibration and aiming can reduce or eliminate detection errors in position of an object by the detector 30 caused by changes in attitude of the vehicle 50. The reference attitude of the vehicle 50 relative to the external environment means an attitude in which the vehicle is horizontal to the ground RD that is a roadway, and may be defined, for example, as the attitude of the vehicle with one driver in the vehicle.

The process flow illustrated in FIG. 13 is performed by the attitude/position detection device 10, that is, the CPU 101 executing the attitude/position detection processing program Pr1, and is performed when an occupant enters or exits the vehicle 50. The attitude/position detection device 10, that is, the CPU 101, functions as the vehicle attitude detection device. The CPU 101 determines whether entering/exiting of the vehicle is occurring (at step S200). The presence or absence of an occupant entering or exiting the vehicle 50 may be detected, for example, not only by the vehicle speed sensor indicating a vehicle speed of 0 km/h, but also by using a detection signal from a door sensor, or by using a detection signal from a trunk sensor that detects that the trunk is open. Alternatively or additionally, the presence or absence of an occupant entering or exiting the vehicle may be detected based on switching between a seated position and a non-seated position of the occupant indicated by a detection signal from a seating sensor that detects the occupant's seated position, or based on transition between a seat-belt wearing state and non-wearing state indicated by a detection signal from a seat-belt sensor. Alternatively or additionally, the presence or absence of an occupant entering or exiting the vehicle 50 may be detected using changes in suspension stroke amount detected by a suspension sensor, or may be detected by the sensor 30 detecting whether there are a plurality of stationary objects around the vehicle that may be potential occupants of the vehicle 50.

If the CPU 101 determines that an occupant entering or exiting the vehicle 50 has not occurred (“NO” branch of step S200), then the CPU 101 ends the processing routine. If the CPU 101 determines that an occupant entering or exiting the vehicle 50 has occurred (step S200: No), the CPU 101 acquires a result of detection of the vehicle attitude and stores it in the memory 102 as a calibration value (step S202). For example, the memory 102 stores initial calibration values of the attitude/position of each detector 30 relative to the vehicle 50, which are measured and acquired at the time of shipment from the factory, and these initial calibration values are values when the attitude of the vehicle 50 is the reference attitude. Therefore, further storing the calibration values based on the results of detection of the vehicle attitude in the memory 102 enables calibration of the detection data from the detector 30 taking into account the vehicle attitude, which allows the detection data to be appropriately utilized according to the attitude of the vehicle 50, which cannot be achieved by the initial calibration values. In the entering/exiting determination, for example, the CPU 101 detects an occupant's entering position using signals from the vehicle attitude sensor 58, and detects changes in vehicle attitude using a map prepared in advance that maps occupant's entering positions to changes in vehicle attitude, for example, amounts of tilt in the longitudinal and lateral directions. Alternatively, signals from each suspension sensor may be used to acquire amounts of suspension stroke for all or rear wheels, and a map that maps pre-populated amounts of stroke and suspension positions to changes in attitude of the vehicle 50, for example, the amounts of tilt in the longitudinal and lateral directions, may be used. The reference attitude of the vehicle may be the attitude of the vehicle before occupants entering and exiting the vehicle. In this case, data on stationary objects around the vehicle 50, such as signals, signboards, and buildings, is acquired by the detection sensors 30 before and after the occupants entering and exiting the vehicle, respectively, and amounts of displacement of the stationary objects on the detection data are calculated. These amounts of displacement are used as amounts of change in tilt of the vehicle attitude. Instead of the detection data before the occupants entering and exiting the vehicle, previously acquired 3D map data of surroundings of the vehicle may be used. In this case, comparing the 3D map data with the detection data after the occupants entering and exiting the vehicle allows the attitude/position deviation of each detector in the coordinate system of the map, that is, the attitude/position of each detector, to be calculated, which enables improvement of the performance accuracy in the case of autonomous driving on the map. Here, the attitude/position deviation calculation may be implemented, for example, using the known Iterative Closest Point (ICP). The detected changes in attitude may be at least two-dimensional coordinate information in the vertical and horizontal directions that is indicative of pitch, which is an amount of tilt of the vehicle 50 in the longitudinal direction, and yaw, which is an amount of tilt in the lateral direction, or may be three-dimensional coordinate information that is further indicative of rolling, which is an amount of rotation of the vehicle 50 about the longitudinal axis.

The CPU 101 calibrates the detectors 30, that is, the detection data acquired from the detectors 30, using the results of detection of the vehicle attitude stored in the memory 102, that is, the calibration values (at step S204), and ends the processing routine. The CPU 101 performs various control processes in the vehicle 50 using the calibrated detection data. Step S204 may not necessarily be included in the process flow illustrated in FIG. 13. When various control processes in the vehicle 50 are performed, the detection data may be calibrated using the calibration values of the vehicle attitude stored in the memory 102.

In accordance with the attitude/position detection system 100 of the second embodiment described above, the attitude of the vehicle 50 is detected in response to occurrence of entering/exiting of the vehicle 50 as a trigger. This enables appropriate detection of changes in vehicle attitude relative to the reference attitude of the vehicle 50 caused by occupants entering or exiting the vehicle, or by loading or unloading luggage. Therefore, calibrating the detection data from the detectors 30 using the detected deviations in attitude of the vehicle 50 relative to the reference attitude as calibration values, after occurrence of entering/exiting of the vehicle 50, can suppress or prevent deterioration of the accuracy of object detection due to changes in attitude of the vehicle 50, that is, deterioration of the accuracy of position information of the object. This can increase the accuracy of performance of various control processes in the vehicle 50, such as driving assistance and autonomous driving, that use the detection results from detectors 30. The vehicle attitude detection device may be provided separately from the attitude/position detection device 10. In such an embodiment, the attitude/position detection device 10 may perform the attitude/position detection process for the detectors 30 relative to the vehicle 50 in the first embodiment as well as the calibration process for the detectors 30.

### Other Embodiments

(1) The attitude/position detection process in the first embodiment may be combined with the attitude/position detection process in the second embodiment. Specifically, the attitude/position detection process in the second embodiment is performed first. After the attitude of the vehicle is detected, the attitude/position detection process in the first embodiment is performed for the detectors 30. In such an embodiment, changes in vehicle attitude can be taken into account for the dynamic detection results of the attitude/position of each detector 30 relative to the vehicle 50, further improving the reliability and accuracy of the detection data from the detectors 30.

(2) In the first embodiment, the attitude/position of each detector 30 relative to the vehicle 50 is detected by determining whether there is any attitude or position deviation between the detected position and the reference position of the open or closed position of the movable component, or between the detected position and the reference position of the home or actuation position of the movable component. Alternatively, the attitude/position of each detector 30 relative to the vehicle 50 may be detected according to a difference between the detected amount and the reference amount of displacement between the open and closed positions of the movable component.

(3) In each of the above embodiments, detection of the attitude/position of each detector 30 relative to the vehicle 50 and detection of the attitude of the vehicle 50 is implemented by the CPU 101 executing the attitude/position detection processing program Pr1, but it can also be implemented in hardware by a pre-programmed integrated circuit or discrete circuits. The control unit and its method described in each of the above embodiments may be implemented by a dedicated computer including a processor and a memory programmed to execute one or more functions embodied by computer programs. Alternatively, the control unit and its method described in the present disclosure may be implemented by a dedicated computer including a processor formed of one or more dedicated hardware logic circuits, or may be implemented by one or more dedicated computers including a combination of a processor and a memory programmed to execute one or more functions and a processor formed of one or more dedicated hardware logic circuits. The computer programs may be stored, as instructions to be executed by a computer, in a non-transitory, tangible computer-readable storage medium.

The present disclosure has been described based on the specific embodiments and modifications. These specific embodiments and modifications are simply for facilitating the understanding of the present disclosure, and are not in any way to be construed as limiting the present disclosure. The present disclosure may variously be changed or altered without departing from its spirit and encompass equivalents thereof. For example, the technical features of the embodiments, examples or modifications corresponding to the technical features of the respective aspects described in the introductory part may be replaced or combined appropriately, in order to solve part or all of the issues described above or in order to achieve part or all of the advantageous effects described above. Any of the technical features may be omitted appropriately unless the technical feature is described as essential herein.

What is claimed is:

1. An attitude/position detection system for a detector mounted to a vehicle, comprising:
an attitude/position detection device configured to use a position change between an open and a closed position or between a home and an actuation position of a movable component of the vehicle to perform attitude/position detection for the detector; and
the detector is mounted to the vehicle such that at least a part of the movable component of the vehicle is included in a detection region.

2. The attitude/position detection system according to claim 1, wherein
the attitude/position detection device is configured to detect an attitude/position of the detector using pre-populated reference position information of an open or closed position or a home or actuation position of the movable component and detected position information of the open or closed position or the home or actuation position of the movable component detected by the detector.

3. The attitude/position detection system according to claim 1, wherein
the movable component is at least one of a hood, a door mirror, a door, a trunk, a seat, and a wiper.

4. The attitude/position detection system according to claim 3, wherein
the movable component is a door that is actuated in an open or closed position by the vehicle.

5. The attitude/position detection system according to claim 1, wherein
the attitude/position detection device is configured to perform the attitude/position detection while the vehicle is stopped.

6. The attitude/position detection system according to claim 1, wherein
the attitude/position detection device is further configured to calibrate the detector using a detected attitude/position of the detector.

7. An attitude/position detection method for a detector mounted to a vehicle such that at least a part of a movable component of the vehicle is included in a detection region of the detector, the attitude/position detection method comprising:
acquiring position information that is information about a position change between an open and a closed position or between a home and an actuation position of the movable component of the vehicle; and
performing attitude/position detection for the detector using the acquired position information.

8. An attitude/position detection system for a detector mounted to a vehicle, comprising:
a vehicle attitude detection device configured to detect a change in attitude of the vehicle using a result of detection of a stationary object around the vehicle by the detector when entering or exiting the vehicle; and
an attitude/position detection device configured to calibrate the detector using the detected change in attitude of the vehicle when entering or exiting the vehicle.

9. An attitude/position detection method for a detector mounted to a vehicle, comprising:
detecting a change in attitude of the vehicle using a result of detection of a stationary object around the vehicle by the detector when entering or exiting the vehicle; and
calibrating the detector using the detected change in attitude of the vehicle when entering or exiting the vehicle.
